(19) United States
(12) Patent Application Publication
(10) Pub. No.: US 2007/0196671 A1
(43) Pub. Date: Aug. 23, 2007

(54) Electromagnetic wave absorber

(75) Inventor: Tatsuya Kobayashi, Shizuoka-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Geltec CO., LTD., Tokyo (JP)

(21) Appl. No.: 10/590,063

(22) PCT Filed: Oct. 20, 2004
(86) PCT No.: PCT/JP04/15488

§ 371 Date: Aug. 21, 2006

(30) Foreign Application Priority Data
Mar. 30, 2004 (JP) 2004-099824
Mar. 30, 2004 (JP) 2004-099849
Mar. 30, 2004 (JP) 2004-099864

(51) Int. Cl. B32B 9/04; B32B 15/00

(52) U.S. Cl. 428/447; 428/450; 428/692.1; 428/693.1

(57) ABSTRACT

An electromagnetic wave absorber comprising (a) soft ferrite having its surface treated with a silane compound having no functional group, (c) magnetite and (d) silicone, or comprising (a) soft ferrite having its surface treated with a silane compound having no functional group, (b) flat, soft magnetic metal powder, (c) magnetite and (d) silicone, which electromagnetic wave absorber excels in electromagnetic wave absorption, heat conduction and flame resistance, exhibiting less temperature dependence, and which electromagnetic wave absorber is soft, excelling in adhesion strength and further excelling in high resistance high insulation properties and in energy conversion efficiency being stable in MHz to 10 GHz broadband frequency. There is further provided a laminated electromagnetic wave absorber comprising the above electromagnetic wave absorber overlaid with a reflection layer of conductor, which laminated electromagnetic wave absorber can be closely stuck onto an unwanted electromagnetic wave emission source such as a high-speed operating device, having such an adhesive strength that even when stuck to a horizontal glassy-surface ceiling face of resin-made cage, would not fall.

### BACKGROUND OF THE INVENTION

1. Field of the Invention

The present invention relates to an electromagnetic wave absorber, electromagnetic wave absorber of broadband frequency characteristics and laminated electromagnetic wave absorber, in particular to an electromagnetic wave absorber and electromagnetic wave absorber of broadband frequency characteristics, excellent in electromagnetic wave absorbing capability, thermal conductivity and flame retardancy, having limited temperature dependency, soft, excellent in adhesive strength, having high electric resistance/insulation characteristics, and fast bonded to widely varying objects; and to laminated electromagnetic wave absorber which can be fast bonded to a box ceiling surface and unnecessary electromagnetic wave radiation source, e.g., high-speed arithmetic element, and is excellent in electromagnetic wave absorbing and shielding capacities.

2. Description of the Prior Art

Recently, troubles caused by electromagnetic waves, e.g., radio interferences and electronic device errors, have been frequently occurring, because of expanded utilization of electromagnetic waves by broadcasting, communication by moving devices, radars, cellular phones, wireless LANs and so forth, which massively scatter electromagnetic waves in living spaces. In particular, unnecessary electromagnetic waves (noises) radiated from elements in devices which generate electromagnetic waves and patterns on printed boards cause interference and resonance phenomena. These problems have called for urgent measures against electromagnetic waves in neighborhood electromagnetic fields, which induce deteriorated device functions and reliability, and increased heat emitted from arithmetic elements which are speeding up increasingly.

Some of the major measures against these problems taken so far include reflection for returning noises back to the source, by-passing for directing noises to a stable potential surface (e.g., by grounding) and shielding.

None of these methods, however, has sufficiently achieved measures against electromagnetic waves in neighborhood electromagnetic fields and increased heat radiation simultaneously for various reasons. Elements are mounted at a higher density to satisfy requirements for compacter and lighter assemblies, which tends to cut spaces for devices for controlling noises. Elements are driven at a lower voltage to satisfy requirements for energy-saving, with the result that their power sources tend to be interfered with high-frequency waves radiated from another medium. Arithmetic elements have narrowed clock signals to satisfy requirements for higher treatment speed, with the result that they are more sensitive to high-frequency waves. Resin boxes tend to have structures which allow electromagnetic waves to leak out more easily as they are rapidly spreading, with the result that they are interfered with each other as available frequency bands rapidly expand.

These tendencies are noted even at a high frequency beyond 1 GHz as digital functional elements, digital circuit units and so forth speed up.

Electromagnetic wave absorbers are now spreading to convert noises, emitted from elements and patterns on printed boards contained in boxes, into heat energy to solve these problems. The absorbers are required to have functions of absorbing electromagnetic energy of noises by utilizing magnetism loss characteristics and converting it into heat energy to control noise reflection and transmission in boxes, and functions of adding an impedance to the electromagnetic energy emitted from board patterns and element terminals working as antennas to deteriorate the antenna effects and thereby to reduce the electromagnetic energy level. There are demands for the absorbers which fully exhibit these functions.

There are also demands for the absorbers which exhibit the effects in a broad frequency band from 1 to 10 GHz.

One of the absorbers proposed to solve these problems is a soft, thin laminate of flexible, sheet-shape absorption layer and wave reflection layer, the former being of a mixture of materials, one for dissipating and the other for retaining electromagnetic energy, and the latter of an organic fiber fabric electrolessly plated with a highly electroconductive metal (JP-B-3097343).

Various measures for shielding electromagnetic waves have been adopted. For examples, some devices are provided with a metallic shielding plate to prevent leakage of electromagnetic waves. Some devices are contained in boxes treated to have electroconductivity and hence electromagnetic wave shielding capability. These shielding materials involve problems, e.g., electromagnetic waves reflected and scattered by them fill device insides to complicate electromagnetic interferences, or cause interferences between boards in a device. One of the proposals to solve these problems is controlling electromagnetic interferences by a laminate of electroconductive supporter coated with an electrically insulating, soft magnetic layer of soft magnetic powder and an organic binder (JP-A-7-212079).

JP-A-2002-329995 discloses a laminated electromagnetic wave absorber composed of an electromagnetic wave reflection layer coated, at least on one side, with an electromagnetic wave absorption layer, where the reflection layer comprises an electroconductive filler dispersed in a silicone resin and the absorption layer comprises an electromagnetic wave absorbing filler dispersed in a silicone resin. It is claimed to have high electromagnetic wave absorbing and shielding capacities, and, at the same time, high moldability, flexibility, weather resistance and heat resistance coming from the silicone resin itself. JP-A-11-335472 discloses a sheet of electromagnetic wave absorbing, thermoconductive silicone gel composition containing magnetic particles of metal oxide (e.g., ferrite) and thermoconductive filler (of metal oxide or the like).

JP-A-2000-243615 discloses a method for producing a composite magnetic film of flat, soft magnetic powder slurried with a binder and solvent. However, it is difficult for this method to have a film of high flat, soft magnetic particle content. Therefore, the film cannot be expected to have a high permeability at a high frequency of 1 GHz or more. JP-A-2001-294752 and JP-A-2001-119189 disclose a curable silicone composition which allows a soft, magnetic material to be well formed even when it contains a soft, magnetic powder at a high content to have excellent electromagnetic wave absorption characteristics. These compositions, however, involve problems of insufficient soft, magnetic particle content and moldability. JP-A-2002-15905 discloses a composite magnetic material for absorbing electromagnetic waves. It contains a flat, soft magnetic powder having an aspect ratio of 20 or more, ferrite powder having a particle size of 100 μm or less and resin binder, where the magnetic powder has well balanced complex permeability and complex dielectric constant to realize efficient conversion of noises into heat energy at a high frequency.

Each of the electromagnetic wave absorbers described above has a structure comprising particles of magnetism dissipating material (e.g., ferrite) and/or particles of dielectricity dissipating material (e.g., carbon) uniformly dispersed in rubber, plastic or the like. However, they involve problems of limited particle content and insufficient flexibility for coating objects of diversified shapes.

An electromagnetic wave absorber, in particular that to be incorporated in a portion with electronic device elements incorporated at a high density and high integration degree in an electronic assembly, is required to have electromagnetic wave absorption capability, electric resistance/insulation characteristics, and thermal conductivity. However, there is no absorber which can simultaneously satisfy these requirements. An absorber for the above applications is also required to have flexibility, heat resistance and flame retardancy, and there is no absorber which can simultaneously satisfy these requirements. In particular, an absorber which also has an electromagnetic wave reflecting function can find limited applicable sites. For example, it cannot be well applicable to a ceiling surface of resin box.

Moreover, each electromagnetic wave absorber described above involve structural problems of limited content of flat, soft magnetic powder or the like, and insufficient flexibility for coating objects of diversified shapes. In particular, there is no absorber which can exhibit similar effects over a frequency range of MHz to 10 GHz, and simultaneously satisfy electromagnetic wave absorption capability, electric resistance/insulation characteristics and thermal conductivity. An absorber for the above applications is also required to have flexibility, heat resistance and flame retardancy, and there is no material which can simultaneously satisfy these requirements.

### SUMMARY OF THE INVENTION

The present invention has been developed to solve the problems described above. It is an object of the present invention to provide an electromagnetic wave absorber excellent in electromagnetic wave absorption capability, thermal conductivity and flame retardancy, having limited temperature dependency, soft, excellent in adhesive strength, having high electric resistance/insulation characteristics, and fast bonded to widely varying objects, these favorable characteristics coming from the developments which allow a magnetism dissipating material to be contained at a high content. It is another object to provide an electromagnetic wave absorber having a stable energy conversion efficiency in a broad frequency band from MHz to 10 GHz, in particular at a high frequency. It is still another object to provide a laminated electromagnetic wave absorber which can absorb unnecessary electromagnetic waves emitted from a resin box inside and outside, comprises the above absorption layer coated with an electroconductive layer for reflecting electromagnetic waves, and is sufficiently adhesive to be fast bonded to an unnecessary electromagnetic wave radiation source, e.g., high-speed arithmetic element, and kept attached to a horizontal glass ceiling surface of resin box.

The inventor of the present invention has found, after having extensively studied to solve the above problems, that a laminated electromagnetic wave absorber exhibits excellent electromagnetic wave absorption capability, thermal conductivity and flame retardancy, limited temperature dependency, softness, excellent adhesive strength, high electric resistance/insulation characteristics, and stable energy conversion efficiency in a broad frequency band from MHz to 10 GHz, when it has a specific composition of surface-treated soft ferrite as a magnetism dissipating filler, flat soft magnetic metal powder showing a high electromagnetic wave absorption effect in a high frequency band, magnetite working as a flame retardancy improver and also as a thermal conductivity improver, and silicone as a soft adhesive material, and that it can be sufficiently adhesive to be fast bonded to an unnecessary electromagnetic wave radiation source, e.g., high-speed arithmetic element and kept attached to a horizontal glass ceiling surface of resin box, when the electromagnetic wave absorption layer contains a binder which allows the layer to be fast attached to the above surface, achieving the present invention.

The first aspect of the present invention is an electromagnetic wave absorber containing (a) soft ferrite surface-treated with a silane compound having a non-functional group at 60 to 90% by mass, (c) magnetite at 3 to 25% by mass and (d) silicone at 7 to 15% by mass.

The second aspect of the present invention is an electromagnetic wave absorber containing (a) soft ferrite surface-treated with a silane compound having a non-functional group at 40 to 60% by mass, (b) flat, soft magnetic metal powder at 20 to 30% by mass, (c) magnetite at 3 to 10% by mass and (d) silicone at 7 to 25% by mass.

The third aspect of the present invention is the electromagnetic wave absorber of the second aspect, wherein ratio of (a) the soft ferrite surface-treated with a silane compound having a non-functional group to (b) the flat, soft magnetic metal powder is 1.8 to 2.3/1 by mass.

The fourth aspect of the present invention is the electromagnetic wave absorber of one of the first to third aspects, wherein (a) the soft ferrite surface-treated with a silane compound having a non-functional group is surface-treated with dimethyldimethoxy silane or methyltrimethoxy silane.

The fifth aspect of the present invention is the electromagnetic wave absorber of one of the first to fourth aspects, wherein (a) the soft ferrite surface-treated with a silane compound having a non-functional group is kept at a pH of 8.5 or less.

The sixth aspect of the present invention is the electromagnetic wave absorber of one of the first to fifth aspects, wherein (a) the soft ferrite surface-treated with a silane compound having a non-functional group is composed of the powder having a particle size distribution D₅₀ of 1 to 30 μm.

The seventh aspect of the present invention is the electromagnetic wave absorber of one of the first to sixth aspects, wherein (a) the soft ferrite surface-treated with a silane compound having a non-functional group is Ni—Zn-based one.

The eighth aspect of the present invention is the electromagnetic wave absorber of one of the second to seventh aspects, wherein (b) the flat, soft magnetic metal powder is of a low self-oxidation type showing a mass change rate of 0.3% or less in an atmospheric exposure test under heating.

The ninth aspect of the present invention is the electromagnetic wave absorber of one of the second to eighth aspects, wherein (b) the flat, soft magnetic metal powder has a specific surface area of 0.8 to 1.2 m²/g.

The tenth aspect of the present invention is the electromagnetic wave absorber of one of the second to ninth aspects, wherein (b) the flat, soft magnetic metal powder is composed of the particles having a size distribution D₅₀ of 8 to 42 μm.

The 11^{th} aspect of the present invention is the electromagnetic wave absorber of one of the second to ninth aspects, wherein (b) the flat, soft magnetic metal powder is microcapsulation-treated.

The 12^{th} aspect of the present invention is the electromagnetic wave absorber of one of the first to 11^{th} aspects, wherein (c) the magnetite is composed of the particles having a size distribution D₅₀ of 0.1 to 0.4 μm.

The 13^{th} aspect of the present invention is the electromagnetic wave absorber of one of the first to 12^{th} aspects, wherein (c) the magnetite is composed of the fine, octahedral particles.

The 14^{th} aspect of the present invention is the electromagnetic wave absorber of one of the first to 13^{th} aspects, wherein (d) the silicone is gelled one having a penetration of 5 to 200, determined in accordance with JIS K2207-1980 (load: 50 g).

The 15^{th} aspect of the present invention is a laminated electromagnetic wave absorber comprising an electromagnetic wave absorption layer of the electromagnetic wave absorber of one of the first to 14^{th} aspects, coated with an electroconductive reflection layer and electrical insulation layer, in this order.

The 16^{th} aspect of the present invention is the laminated electromagnetic wave absorber of the 15^{th} aspect which can absorb unnecessary electromagnetic waves emitted from a resin box inside and outside, comprises the electromagnetic wave absorption layer coated with an electroconductive layer for reflecting electromagnetic waves, electric insulation layer and adhesive layer, in this order, each of the electromagnetic wave absorption layer and adhesive layer being coated with a releasable film layer on the other side, wherein the electromagnetic wave absorption layer is sufficiently adhesive to be fast bonded at least to a high-speed arithmetic element, and adhesive layer can be kept attached at least to a horizontal glass ceiling surface.

The 17^{th} aspect of the present invention is the laminated electromagnetic wave absorber of the 15^{th} or 16^{th} aspect, wherein an electrical insulation layer is provided between the electromagnetic wave absorption layer and electromagnetic wave reflection layer.

The 18^{th} aspect of the present invention is the laminated electromagnetic wave absorber of one of the 15^{th} to 17^{th} aspects, wherein the electromagnetic wave reflection layer is a metallic layer of aluminum.

The 19^{th} aspect of the present invention is the laminated electromagnetic wave absorber of one of the 15^{th} to 18^{th} aspects, wherein the adhesive layer is of an acrylic resin.

The 20^{th} aspect of the present invention is the laminated electromagnetic wave absorber of one of the 15^{th} to 19^{th} aspects, wherein the electric insulation layer is of a polyethylene terephthalate resin.

The electromagnetic wave absorber of the present invention brings many advantages of being excellent in electromagnetic wave absorption capability, thermal conductivity and flame retardancy, having limited temperature dependency, being soft, excellent in adhesive strength, having high electric resistance/insulation characteristics, and fast bonded to widely varying objects.

It also brings an advantage of stable energy conversion efficiency in a broad frequency band from MHz to 10 GHz, in addition to many advantages of being excellent in electromagnetic wave absorption capability, thermal conductivity and flame retardancy, having limited temperature dependency, being soft, excellent in adhesive strength, having high electric resistance/insulation characteristics, and fast bonded to widely varying objects.

Moreover, the laminated electromagnetic wave absorber of the present invention, comprising a releasable layer, the electromagnetic wave absorption layer, electromagnetic wave reflection layer, electric insulation layer, adhesive layer and releasable layer in this order, can be applicable to wide uses by one product type. Therefore, it brings advantages of being fast bonded to a box ceiling surface, high-speed arithmetic element and so forth while exhibiting excellent electromagnetic wave absorption and shielding capacities.

### BRIEF DESCRIPTION OF THE DRAWINGS

FIG. 1 presents the magnetism loss measurement results of the electromagnetic wave absorbers of EXAMPLES and COMPARATIVE EXAMPLES.

FIG. 2 is a cross-sectional view of a laminated electromagnetic wave absorber.

FIG. 3 illustrates one application of laminated electromagnetic wave absorber.

FIG. 4 illustrates another application of laminated electromagnetic wave absorber.

FIG. 5 illustrates still another application of laminated electromagnetic wave absorber.

FIG. 6 presents the electromagnetic wave absorbances in a neighborhood electromagnetic field, measured in EXAMPLES.

### NOTATION

1 Electromagnetic wave absorption layer
2 Electromagnetic wave reflection layer
3 Electric insulation layer
4 Adhesive layer
5, 6 Releasable layer
10, 10′, 15 Board
11, 11′, 12, 12′ High-speed arithmetic element
20 Box
21 Box ceiling surface

### DETAILED DESCRIPTION OF THE INVENTION

The present invention provides an electromagnetic wave absorber containing (a) soft ferrite, (c) magnetite and (d) silicone; electromagnetic wave absorber containing (a) soft ferrite, (b) flat, soft magnetic metal powder, (c) magnetite and (d) silicone; and laminated electromagnetic wave absorber comprising a releasable layer, electromagnetic wave absorption layer of the electromagnetic wave absorber of the above-described electromagnetic wave absorber, electroconductive electromagnetic reflection layer, electric insulation layer, adhesive layer and releasable layer in this order. The constituent components of the absorber, method for producing the absorber and so forth are described below.

1. Constituent Components of the Electromagnetic Wave Absorber

(a) Soft Ferrite

Soft ferrite for the electromagnetic wave absorber of the present invention is selected from the ones which can exhibit magnetic function even at a very low excitation current. The soft ferrite is not limited for the present invention. Examples of the soft ferrites useful for the present invention include Ni—Zn, Mn—Zn, Mn—Mg, Cu—Zn, Ni—Zn—Cu, Fe—Ni—Zn—Cu, Fe—Mg—Zn—Cu and Fe—Mn—Zn ferrites, of which Ni—Zn ferrite is more preferable in consideration of a balance among electromagnetic wave absorption characteristics, thermal conductivity, cost and so forth.

The soft ferrite particle is not limited in shape. It may take any desired shape, e.g., spherical, fibrous or indefinite. It is preferably spherical for the present invention, because the soft ferrite can be densely packed to give a higher thermal conductivity. The spherical soft ferrite powder can have a particle size at which it is densely packed and, at the same time, prevented from agglomerating with each other to facilitate the mixing work.

The spherical Ni—Zn ferrite particles are well dispersible in silicone gel, described later, without inhibiting cure of the gel while exhibiting thermal conductivity to some extent.

The soft ferrite has a particle size distribution D₅₀ of 1 to 30 μm, preferably 10 to 30 μm. It is more preferably 1 to 10 μm for the electromagnetic wave absorber incorporated with (b) flat, soft magnetic metal powder. The distribution D₅₀ beyond the above range is not desirable. When it is below 1 μm, the absorber may have a deteriorated electromagnetic wave absorption capability at a low frequency band of 500 MHz or less. When it is above 30 μm, on the other hand, the absorber may have deteriorated flatness/smoothness.

The particle size distribution D₅₀ represents a size range around the midpoint in a cumulative distribution in which sizes determined by a particle size distribution meter are arranged in an ascending order.

It is necessary to treat the soft ferrite for the present invention with a silane compound having a non-functional group, in order to control effects of the alkali ion remaining on the surface. The soft ferrite is incorporated in silicone described later, and the alkali ion remaining on the surface may inhibit cure of the silicone effected by a condensation or addition mechanism. When cure of the silicone is inhibited, the soft ferrite may be insufficiently packed and dispersed.

The soft ferrite surface-treated with a silane compound having a non-functional group has a pH of 8.5 or less, preferably 8.2 or less, more preferably 7.8 to 8.2. Keeping the soft ferrite at a pH of 8.5 or less controls the inhibition effect on cure of the silicone and makes it applicable to any type of silicone. Moreover, it improves compatibility of the soft ferrite with the silicone, allowing it to be incorporated in the silicone at a higher content and increasing its compatibility with a thermoconductive filler to make the formed article more uniform.

The silane compounds having a non-functional group useful for the present invention for surface treatment of the soft ferrite include methyltrimethoxy silane, phenyltrimethoxy silane, diphenyldimethoxy silane, methyltriethoxy silane, dimethyldimethoxy silane, phenyltriethoxy silane, diphenyldiethoxy silane, isobutyltrimethoxy silane and decyltrimethoxy silane, of which dimethyldimethoxy silane and methyltrimethoxy silane are more preferable. They may be used either individually or in combination.

A common silane coupling agent having a functional group, e.g., epoxy- or vinyl-based one, which is used for surface treatment of filler or the like, is not desirable for surface treatment of the soft ferrite for the present invention, because it may cause hardness change of increased hardness in an environment test carried out under heating. The increased hardness, when occurs, may lead to cracking or the like caused by thermal decomposition and damages of external appearance.

The method for surface treatment of the soft ferrite with the silane compound having a non-functional group is not limited, and a common method with an inorganic compound, e.g., silane compound, may be adopted. For example, the soft ferrite is immersed in a methyl alcohol solution containing dimethyldimethoxy silane at around 5% by mass to be mixed with the silane compound, to which water is added for hydrolysis, and the product is then milled and mixed by a Henschel mixer and the like. The silane compound having a non-functional group is preferably incorporated at around 0.2 to 10% by mass on the soft ferrite.

The electromagnetic wave absorber of the present invention comprising the components (a), (c) and (d) is incorporated with the soft ferrite at 60 to 90% by mass, preferably 75 to 85% by mass. The soft ferrite incorporated at a content in the above range can impart sufficient electromagnetic wave absorption, thermal conductivity and electrical insulation characteristics to the absorber, and secure good absorber moldability. At below 60% by mass, the absorber may not have sufficient electromagnetic wave absorption capability. At above 90% by mass, on the other hand, the absorber may be difficult to form into a sheet.

The electromagnetic wave absorber of the present invention comprising the components (a), (b), (c) and (d) is incorporated with the soft ferrite at 40 to 60% by mass, preferably 45 to 55% by mass. The soft ferrite incorporated at a content in the above range can impart sufficient electromagnetic wave absorption, thermal conductivity and electrical insulation characteristics to the absorber, and secure good absorber moldability. At below 40% by mass, the absorber may not have sufficient electromagnetic wave absorption capability. At above 60% by mass, on the other hand, the absorber may be difficult to form into a sheet.

(b) Flat, Soft Magnetic Metal Powder

Flat, soft magnetic metal powder as the component (b) for the electromagnetic wave absorber of the present invention is a material which has an effect of securing a stable energy conversion efficiency in a high frequency band.

The flat, soft magnetic metal powder as the component (b) is not limited, so long as it exhibits soft magnetism and can be mechanically flattened. It preferably has a high permeability, low self-oxidation rate and shape of high aspect ratio (average particle size divided by average thickness). More specifically, the metals useful for the component (b) include soft magnetic ones, e.g., Fe—Ni, Fe—Ni—Mo, Fe—Ni—Si—B, Fe—Si, Fe—Si—Al, Fe—Si—B, Fe—Cr, Fe—Cr—Si, Co—Fe—Si—B, Al—Ni—Cr—Fe and Si—Ni—Cr—Fe alloys, of which Al-based and Si—Ni—Cr—Fe alloys are more preferable particularly viewed from their low self-oxidation rate. They may be used either individually or in combination.

Degree of self-oxidation can be measured by mass change of a sample, determined by an atmospheric exposure test under heating. It is preferable that the degree is 0.3% by mass or less when a sample is kept at 200° C. in air for 300 hours. Flat, soft magnetic metal powder of low self-oxidation rate has an advantage of being resistant to temporal aging in magnetic characteristics resulting from changed ambient conditions, e.g., humidity, even when they are incorporated with a highly moisture-permeable silicone gel or the like as a binder resin.

Powder of low self-oxidation rate has another advantage that it can be massively stored and handled easily to improve productivity, because it involves no risk of dust explosion and considered to be non-hazardous.

The flat, soft magnetic metal powder for the present invention preferably has an aspect ratio of 10 to 150, more preferably 17 to 20, and tap density of 0.55 to 0.75 g/ml. It is preferably surface-treated with an oxidation inhibitor.

The flat, soft magnetic metal particles preferably have an average thickness of 0.01 to 1 μm. The particles having an average thickness of below 0.01 μm may have deteriorated dispersibility in a resin, and may not be sufficiently oriented unidirectionally when orientation-treated in an external magnetic field. At the same time, they may have deteriorated magnetic properties (e.g., permeability) and magnetism shielding characteristics, even when they are of the same composition. On the other hand, those having an average thickness of above 1 μm may not be packed at a sufficient density. They are more sensitive to a diamagnetic field, because of decreased aspect ratio, which leads to deteriorated permeability and hence insufficient shielding characteristics.

The flat, soft magnetic metal powder preferably has a particle size distribution D₅₀ of 8 to 42 μm. The powder having a particle size distribution D₅₀ of below 8 μm may have a deteriorated energy conversion efficiency. On the other hand, the particles having a size distribution D₅₀ of above 42 μm may have a deteriorated mechanical strength and tend to be broken when mechanically treated for mixing.

The particle size distribution D₅₀ represents a size range around the midpoint in a cumulative distribution in which sizes determined by a particle size distribution meter are arranged in an ascending order.

The flat, soft magnetic metal powder preferably has a specific surface area of 0.8 to 1.2 m²/g. It functions to convert energy by electromagnetic induction, and can have an increased energy conversion efficiency as its specific area increases. Increased specific surface area, however, is accompanied by decreased mechanical strength. Therefore, it should be within an optimum range. The powder having a specific surface area of below 0.8 m²/g can be densely packed but has a deteriorated energy conversion. On the other hand, the powder having a specific surface area of above 1.2 m²/g tends to be broken when mechanically treated for mixing, difficult to retain the absorber shape, and shows a deteriorated energy conversion function even when densely packed.

The specific surface area is determined by a BET tester.

The flat, soft magnetic metal powder for the present invention is preferably microcapsulation-treated before use. It tends to have a deteriorated volumetric resistance and dielectric breakdown strength, when packed together with soft ferrite or the like. Microcapsulation can not only prevent deterioration of its dielectric breakdown strength but also improve the strength.

Any microcapsulation method may be adopted, so long as it uses a material which can coat the flat, soft magnetic metal particle surfaces to some extent and is not harmful to energy conversion efficiency of the powder.

For example, it may use gelatin to coat the flat, soft magnetic metal particle surfaces, where the particles are dispersed in a toluene solution of gelatin and then toluene is removed by evaporation to produce the microcapsulated particles coated with gelatin. For example, the microcapsulated particles composed of gelatin and the flat, soft magnetic metal powder at about 20 and 80% by mass can have a size of about 100 μm. The microcapsulation treatment can almost double dielectric breakdown strength of the electromagnetic wave absorber.

The flat, soft magnetic metal powder as the component (b) is incorporated in the electromagnetic wave absorber of the present invention, composed of the components (a), (b), (c) and (d), at 20 to 30% by mass. It can give the electromagnetic wave absorber of high energy conversion efficiency, when incorporated at a content in the above range. An insufficient energy conversion efficiency may result at a content of below 20% by mass. At above 30% by mass, on the other hand, mixing of these components may be difficult.

The electromagnetic wave absorber of the present invention is preferably incorporated with (a) soft ferrite and (b) flat, soft magnetic metal powder at an (a)/(b) ratio of 1.8 to 2.3/1.0 by mass, more preferably 1.9 to 2.2/1.0. It may be difficult to keep a balance between energy conversion efficiency and to form into a sheet at a ratio beyond the above range.

(c) Magnetite

Magnetite as the component (c) for the electromagnetic wave absorber of the present invention is iron oxide (Fe³O⁴), and can impart flame retardancy to the absorber and improve its thermal conductivity, when used in combination with the soft ferrite. Moreover, it can improve electromagnetic wave absorption effect of the absorber as a whole by the synergistic effect with the soft ferrite, brought by its magnetic characteristics.

The magnetite preferably has a particle size distribution D₅₀ of 0.1 to 0.4 μm. It allows the soft ferrite to be densely packed, when its particle size distribution D₅₀ is kept at about one-tenth of that of the soft ferrite. The magnetite may be difficult to handle when its distribution D₅₀ is below 0.1 μm. It may not be densely packed together with the soft ferrite when its distribution D₅₀ exceeds 0.4 μm.

The particle size distribution D₅₀ represents a size range around the midpoint in a cumulative distribution in which sizes determined by a particle size distribution meter are arranged in an ascending order.

The magnetite particle is not limited in shape. It may take any desired shape, e.g., spherical, fibrous or indefinite. It is preferably fine and octahedral for the present invention to realize the electromagnetic wave absorber of high flame retardancy. The fine, octahedral magnetite particles can have a large specific surface area and high effect of imparting flame retardancy.

The magnetite as the component (c) is incorporated in the electromagnetic wave absorber of the present invention, composed of the components (a), (c) and (d), at 3 to 25% by mass, preferably 5 to 10% by mass. An insufficient flame retardancy effect may result at a content of below 3% by mass. At above 25% by mass, on the other hand, the electromagnetic wave absorber may bear magnetism to have an adverse effect on an ambient electronic device.

The magnetite as the component (c) is incorporated in the electromagnetic wave absorber of the present invention, composed of the components (a), (b), (c) and (d), at 3 to 25% by mass, preferably 3 to 10% by mass. An insufficient flame retardancy effect may result at a content of below 3% by mass. At above 25% by mass, on the other hand, the electromagnetic wave absorber may bear magnetism to have an adverse effect on an ambient electronic device.

(d) Silicone

Silicone as the component (d) for the electromagnetic wave absorber of the present invention works as a binder for the ferrite, flat, soft magnetic metal powder and magnetite. It also exhibits a function of reducing temperature-dependence of the electromagnetic wave absorber, allowing it to be used over a wide temperature range from −20 to 150° C. Silicone as the component (d) may be optionally selected from various ones known so far and commercialized as silicone materials. It may be curable under heating or at normal temperature. Moreover, it may be curable by a mechanism of condensation or addition. The group bound to the silicon atom is not limited. For example, it may be an alkyl group, e.g., methyl, ethyl or propyl; cycloalkyl group, e.g., cyclopentyl or cyclohexyl; alkynyl group, e.g., vinyl or allyl; or aryl group, e.g., phenyl or tolyl. Moreover, it may have the hydrogen atom partly substituted by another atom or coupling group.

The silicone for the electromagnetic wave absorber of the present invention may be in the form of gel. The silicone gel, when cured, may have a penetration of 5 to 200, determined in accordance with JIS K2207-1980 (load: 50 g). The silicone gel of such softness is advantageous in adhesiveness, when formed into a shape. The electromagnetic wave absorber of the present invention is sufficiently adhesive to be fast bonded at least over to a high-speed arithmetic element.

The silicone as the component (d) is incorporated in the electromagnetic wave absorber of the present invention, composed of the components (a), (c) and (d), at 7 to 15% by mass, preferably 10 to 14% by mass. The electromagnetic wave absorber may be difficult to form into a sheet, when incorporated with the silicone at below 7% by mass. It may not exhibit a sufficient electromagnetic wave absorption capability, when incorporated with the silicone at above 15% by mass. The silicone as the component (d) is incorporated in the electromagnetic wave absorber of the present invention, composed of the components (a), (b), (c) and (d), at 7 to 25% by mass, preferably 15 to 25% by mass. The electromagnetic wave absorber may be difficult to form into a sheet, when incorporated with the silicone at below 7% by mass. It may not exhibit a sufficient electromagnetic wave absorption capability, when incorporated with the silicone at above 25% by mass.

The electromagnetic wave absorber of the present invention may be incorporated with another species of component at a content within limits not harmful to the object of the present invention. Some of these components include a catalyst, curing retardant, curing promoter and colorant.

2. Production of the Electromagnetic Wave Absorber

The electromagnetic wave absorber of the present invention is a composite material layer comprising the above-described components; (a) soft ferrite, (b) flat, soft magnetic metal powder and (c) magnetite, incorporated in (d) silicone resin. These components (a) to (d) may be combined for specific purposes. For example, the electromagnetic wave absorber for (i) high electric resistance/insulation characteristics preferably comprises the components (a), (c) and (d). For (ii) high electromagnetic wave absorption capability in a band of from 2 to 4 GHz, it preferably comprises the components (b), (c) and (d). For (iii) characteristics in a wide frequency band, it preferably comprises the components (a), (b), (c) and (d).

The electromagnetic wave absorber layer for the object (i) preferably has a composition comprising (a) soft ferrite surface-treated with a silane compound having a non-functional group at 60 to 90% by mass, (c) magnetite at 3 to 25% by mass and (d) silicone at 7 to 15% by mass. The electromagnetic wave absorber layer for the object (ii) preferably has a composition comprising (b) flat, soft magnetic metal powder at 60 to 70% by mass, (c) magnetite at 3 to 10% by mass and (d) silicone at 20 to 37% by mass. The electromagnetic wave absorber layer for the object (iii) preferably has a composition comprising (a) soft ferrite surface-treated with a silane compound having a non-functional group at 40 to 60% by mass, (b) flat, soft magnetic metal powder at 20 to 30% by mass, (c) magnetite at 3 to 10% by mass and (d) silicone at 7 to 25% by mass.

The electromagnetic wave absorber of the present invention can be produced from a mixture comprising soft ferrite, flat, soft magnetic metal powder and magnetite densely packed in silicone, as described earlier. A compound of an inorganic filler, e.g., ferrite, flat, soft magnetic metal powder or magnetite, densely packed in silicone rubber is generally too viscous to be kneaded by a roll or kneader (e.g., Bunbury kneader). Even when kneaded, it is too viscous to be formed into a shape of uniform thickness by compression molding. On the other hand, use of silicone gel allows a compound to be easily kneaded by a chemical mixer, even when it contains a densely packed inorganic filler, and can be easily formed into a sheet of uniform thickness by a common sheet molder. Moreover, the soft ferrite for the present invention brings an advantage of being easily treated, e.g., by kneading, because it is surface-treated with a silane compound having a non-functional group. When roll-kneaded, silicone containing densely packed ferrite loses strength for holding ferrite and hence structural integrity, and, moreover, tends to stick to roll surfaces. It is therefore difficult to produce a homogeneous compound by roll kneading. On the other hand, the soft ferrite for the present invention brings another advantage of being easily formed into a ferrite-containing sheet or the like, because it is surface-treated with a silane compound having a non-functional group to be well dispersed in silicone. Moreover, microcapsulation of the flat, soft magnetic metal powder brings an advantage of further facilitating treatment, e.g., kneading.

The electromagnetic wave absorber of the present invention, comprising the components (a), (c) and (d), is excellent in electromagnetic wave absorbing capability, thermal conductivity and flame retardancy, having limited temperature dependency, soft, excellent in adhesive strength, and having high electric resistance/insulation characteristics. In particular, it is well balanced in high electric resistance/insulation characteristics, thermal conductivity and electromagnetic wave absorbing capability. As such, it can be bonded to widely varying objects, not limited to a specific noise sources but to any noise source, e.g., cable, high-speed arithmetic element, pattern on a printed board and so forth.

3. The Laminated Electromagnetic Wave Absorber

The laminated electromagnetic wave absorber of the present invention comprises an electromagnetic wave absorption layer of the above-described electromagnetic wave absorber, coated with an electroconductive reflection layer. It preferably absorbs unnecessary electromagnetic waves emitted from a resin box inside and outside, and comprises the electromagnetic wave absorption layer coated with an electroconductive reflection layer, electric insulation layer and adhesive layer, in this order. Moreover, the above layered structure is coated with a releasable film layer on each side. The electromagnetic wave absorption layer is sufficiently adhesive to be fast bonded at least to a high-speed arithmetic element, and the adhesive layer is sufficiently adhesive to keep the laminated structure attached to a horizontal glass ceiling surface.

(1) Electromagnetic Wave Absorption Layer

The electromagnetic wave absorption layer is of the electromagnetic wave absorber of the present invention, which is a composite material comprising the above-described components; (a) soft ferrite, (b) flat, soft magnetic metal powder and (c) magnetite, incorporated in (d) silicone resin, where these components (a) to (d) may be combined for specific purposes.

The electromagnetic wave absorption layer is not limited in shape, and may take any desired shape for specific purposes. When it is in the form of sheet, it is preferably 0.5 to 5.0 mm thick. It may be used individually, or 2 to 3 sheets may be put on top of another.

(2) Electromagnetic Wave Reflection Layer

The laminated electromagnetic wave absorber of the present invention can have improved electromagnetic energy attenuation capability simply and at a low cost by the shielding effect for continuous attenuation by reflection and also by conversion of electromagnetic energy into thermal energy by the electromagnetic wave absorption layer, even it is in the form of thin sheet. The improved attenuation capability comes from coating the electromagnetic wave absorption layer with the reflection layer. The material for the electromagnetic wave reflection layer is not limited. It may be of an electroconductive material, e.g., aluminum, copper, stainless steel or the like. A resin film or the like may be coated with an aluminum foil or aluminum layer deposited by evaporation.

The reflection layer for the present invention may be placed on the electromagnetic wave absorption layer either directly or indirectly via an electric insulation layer.

(3) Electric Insulation Layer

It is necessary for the laminated electromagnetic wave absorber of the present invention to have an electric insulation layer on the electromagnetic wave reflection layer, which is provided on the electromagnetic wave absorption layer. The insulation layer is composed of a film of an electrically insulating material, e.g., polyethylene terephthalate (PET), polypropylene or polystyrene resin. It works not only to prevent deterioration of, but also to improve, dielectric breakdown strength of the electromagnetic wave absorber.

The insulation layer may be also provided between the electromagnetic wave absorption layer and reflection layer, as required.

It is preferably 25 to 75 μm thick.

It may be put with an adhesive agent of acrylic resin or the like.

(4) Adhesive Layer

The laminated electromagnetic wave absorber of the present invention has an adhesive layer on the insulation layer, which is provided on the electromagnetic wave reflection layer. It is sufficiently adhesive to keep the laminated structure fast attached to a horizontal glass ceiling surface. It allows the laminated electromagnetic wave absorber to be applicable to a box ceiling surface and side, expanding its applicable area.

The adhesive agent for the adhesive layer is not limited. It may be of an acrylic resin.

Moreover, it is preferable that the insulation layer of a PET film or the like is coated, on one side, with an adhesive layer and releasable film by molding to form the integrated structure.

(5) Releasable Film Layer

The laminated electromagnetic wave absorber of the present invention are provided with releasable film layers one on the electromagnetic wave absorption layer and the other on the adhesive layer. It is of an electrically insulating material, e.g., PET, polypropylene or polystyrene resin, and preferably 20 to 30 μm thick. It is bonded to the electromagnetic wave absorption layer by tackiness of the silicone gel in the layer, or to the adhesive layer by adhesive strength of the layer.

4. Layered Structure of the Laminate and Use of the Laminate

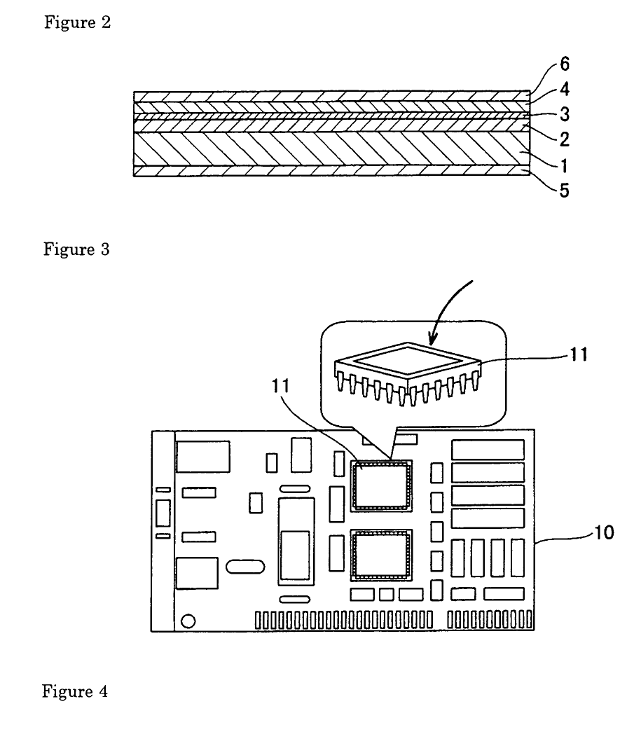

The laminated electromagnetic wave absorber of the present invention comprises the layers described above. FIG. 2 is a cross-sectional view illustrating one embodiment of the laminate, where 1: electromagnetic wave absorption layer, 2: electromagnetic wave layer, 3: electric insulation layer, 4: adhesive layer, and 5 and 6: releasable film layer.

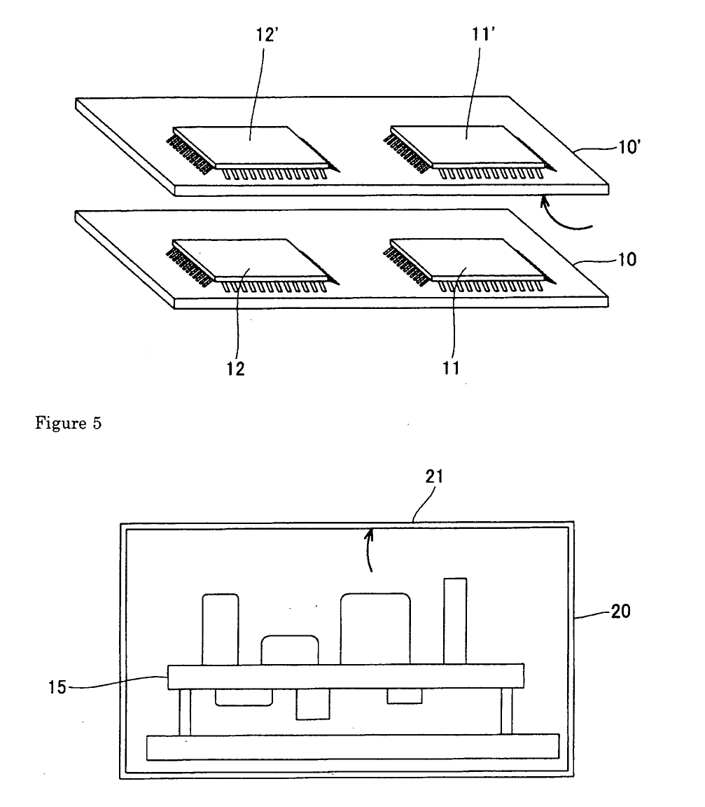

The laminated electromagnetic wave absorber of the present invention is used in such a way that unnecessary electromagnetic waves always enter the electromagnetic wave absorption layer first and is then reflected by the electromagnetic wave reflection layer. Examples of use are described by referring to FIGS. 3 to 5. When an unnecessary electromagnetic wave source, e.g., high-speed arithmetic element, cable or pattern, is identified, for example when the high-speed arithmetic element 11 supported by the board 10 shown in FIG. 3 is identified as an unnecessary electromagnetic wave source, the laminated electromagnetic wave absorber is placed on the element 11 in the arrowed direction shown in the enlarged view of the element 11 in such a way that the electromagnetic wave absorption layer 1 is directly bonded to the element 11 by its tackiness, after the releasable layer 5 is removed from the layer 1. When an unnecessary electromagnetic wave source is not identified and the laminated electromagnetic wave absorber can be placed on a board, it can be bonded to the board after the releasable layer 5 is removed from the layer 1. In the case of a board of multi-layered structure, it can be placed between the boards. Consider that the adhesive layer is to be bonded to the lower side of an upper board. By referring to FIG. 4, when the laminated electromagnetic wave absorber is placed between the boards 10 and 10′ to protect the board 10′ from unnecessary electromagnetic waves emitted from the sources 11 and 12 (e.g., high-speed arithmetic elements) on the board 10, the adhesive layer 4 is bonded in the arrowed direction to the lower side of the board 10, after the releasable layer 6 is removed from the layer 4. The laminated electromagnetic wave absorber can be also used when an unnecessary electromagnetic wave source is not identified and it cannot be placed on a board. By referring to FIG. 5, the board 15 supports a cable, pattern, element and so forth in the box 20, where which is an unnecessary electromagnetic wave source cannot be identified and the laminated electromagnetic wave absorber cannot be bonded to the board 15. In this case, the adhesive layer 4 is bonded to the box ceiling plate 21 in the arrowed direction after the releasable layer 6 is removed from the layer 4, to prevent reflection and transmission of unnecessary electromagnetic waves outwards. As described above, the laminated electromagnetic wave absorber of the present invention is applicable by one product type to widely varying unnecessary electromagnetic wave sources.

### EXAMPLES

The present invention is described in detail by EXAMPLES which by no means limit the present invention. The properties and evaluations in EXAMPLES were determined by the following methods.
(1) Penetration: determined in accordance with JIS K 2207-1980
(2) Magnetism loss (permeability): determined by a permeability/induction rate analyzing system (S parameter type coaxial tube er, μr analyzing system, Anritsu & Keycom)
(3) Volumetric resistance: determined in accordance with JIS K 6249
(4) Dielectric breakdown strength: determined in accordance with JIS K
(5) Thermal conductivity: determined in accordance with the QTM method (Kyoto Electronics Manufacturing)
(6) Flame retardancy: determined in accordance with UL94
(7) Heat resistance: The sample was heated at constant 150° C. to determine penetration and thermal conductivity changing with time, and marked with ∘ when it showed no change for 1000 hours or more and with x when it showed a change in 1000 hours.
(8) External appearance: The surface color was visually observed, where the color black came from magnetite incorporated in the sample.
(9) Moldability (mass-producibility): The sample was marked with ∘ when it was moldable into a sheet by a sheet molder, and with x when it was not.
(10) Absorbance: determined by an analyzer for electromagnetic wave absorber material in neighborhood electromagnetic fields (Keycom)
(11) Self-oxidation rate: About 10 g of a metal powder, spread on a Petri dish (diameter: 100 mm), was kept at 200° C. in an atmospheric oven for 300 hours, withdrawn from the oven, cooled to room temperature, and weighed by an electronic balance, to determine rate of mass change before and after the test.

### Example 1

A mixture of 83% by mass of Ni—Zn-based soft ferrite (BSN-828, Toda Kogyo, particle size distribution D₅₀: 10 to 30 μm) surface treated with methyltrimethoxy silane, 5% by mass of fine magnetite particles of octahedral shape (KN-320, Toda Kogyo, particle size distribution D₅₀: 0.1 to 0.4 μm) and 12% by mass of silicone gel (CF-5106, Toray-Dow Corning Silicone, penetration: 150, determined in accordance with JIS K2207-1980 at a load of 50 g) was prepared, defoaming-treated under a vacuum, poured into a space between glass plates carefully to prevent air from getting in the mixture, and pressed under heating at 70° C. for 60 minutes, to produce a 1 mm thick formed article of smooth surface. The evaluation results of the formed article are given in Table 1.

### Example 2

A formed article was prepared in the same manner as in EXAMPLE 1, except that the magnetite and silicone gel contents were changed as shown in Table 1. The evaluation results of the formed article are given in Table 1.

### Comparative Example 1

A formed article was prepared in the same manner as in EXAMPLE 1, except that the soft ferrite was not surface-treated, the magnetite was not incorporated and the silicone content was changed as shown in Table 1. The soft ferrite inhibited curing of the silicone even at a low 20% by mass, when it was not surface-treated, failing to produce a satisfactory article. The evaluation results of the formed article are given in Table 1.

### Comparative Example 2

A formed article was prepared in the same manner as in EXAMPLE 1, except that the soft ferrite was surface-treated with epoxy trimethoxy silane as a silane compound containing a functional group. The evaluation results of the formed article are given in Table 1. The formed article was insufficient in heat resistance.

### Comparative Example 3

A formed article was prepared in the same manner as in EXAMPLE 1, except that the soft ferrite was surface-treated with vinyl trimethoxy silane as a silane compound containing a functional group. The evaluation results of the formed article are given in Table 1. The formed article was insufficient in heat resistance.

### Comparative Example 4

A formed article was prepared in the same manner as in EXAMPLE 1, except that the magnetite content was set at below the range for the present invention, and the soft ferrite and silicone contents were also changed as shown in Table 1. The evaluation results of the formed article are given in Table 1. The formed article was insufficient in flame retardancy.

### Comparative Example 5

A formed article was prepared in the same manner as in EXAMPLE 1, except that the silicone content was set at above the range for the present invention, and the soft ferrite content was also changed as shown in Table 1. The evaluation results of the formed article are given in Table 1. The formed article was insufficient in electromagnetic wave absorption capability.

### Comparative Example 6

A formed article was prepared in the same manner as in EXAMPLE 1, except that the silicone content was set at below the range for the present invention, and the soft ferrite and magnetite contents were also changed as shown in Table 1. The evaluation results of the formed article are given in Table 1. The formed article was insufficient in moldability.

### Comparative Example 7

A formed article was prepared in the same manner as in EXAMPLE 1, except that the magnetite content was set at above the range for the present invention, and the soft ferrite and silicone contents were also changed as shown in Table 1. The evaluation results of the formed article are given in Table 1. The formed article was insufficient in electromagnetic wave absorption capability, and caused magnetism residue.

TABLE 1

| | | | | EXAMPLES | | COMPARATIVE EXAMPLES | | |
|---|---|---|---|---|---|---|---|---|
| | | | | 1 | 2 | 1 | 2 | 3 |
| Electromagnetic | Soft ferrite | D₅₀ | μm | 10˜30 | 10˜30 | 10˜30 | 10˜30 | 10˜30 |
| wave absorber | (a) | Surface treatment | — | Methyltrimethoxy | Methyltrimethoxy | Untreated | Epoxy trimethoxy | Vinyl |
| composition | | agent | | silane | silane | | silane | trimethoxy |
| | | | | | | | | silane |
| | | pH after surface | | <8.2 | <8.2 | >8.5 | <8.2 | <8.2 |
| | | treatment | | | | | | |
| | | Content | wt % | 83 | 83 | 20 (upper limit) | 83 | 83 |
| | Magnetite | D₅₀ | μm | 0.1˜0.4 | 0.1˜0.4 | — | 0.1˜0.4 | 0.1˜0.4 |
| | (c) | Content | wt % | 5 | 10 | 0 | 5 | 5 |
| | Silicone | Penetration | — | 150 | 150 | 150 | 150 | 150 |
| | (d) | Content | wt % | 12 | 7 | 80 | 12 | 12 |

| | | | | | | | |
|---|---|---|---|---|---|---|---|
| Electromagnetic | Magnetism loss(1 GHz) | μ″ | 4.0 | 4.2 | 0.5 | 4.0 | 4.0 |
| wave absorber | Volumetric resistance | Ωm | 2 × 10¹¹ | 2 × 10¹⁰ | 2 × 10¹⁴ | 2 × 10¹¹ | 2 × 10¹¹ |
| evaluation | Dielectric breakdown strength | KV/mm | 4.5 | 2.5 | >10 | 4.5 | 4.5 |
| results | Thermal conductivity | W/m · K | 1.2 | 1.3 | — | 1.2 | 1.2 |
| | Specific gravity | — | 2.8 | 2.8 | — | 2.8 | 2.8 |
| | Penetration | — | 60 | 60 | — | 60 | 40 |
| | Flame retardancy (UL94) | — | V-0 | V-0 | — | V-0 | V-0 |
| | | | equivalent | equivalent | | equivalent | equivalent |
| | Heat resistance (150° C.) | — | ∘ | ∘ | — | x | x |
| | External appearance | — | Black | Black | Brown | Black | Black |
| | Moldability (mass producibility) | — | ∘ | ∘ | ∘ | ∘ | ∘ |

| | | | | COMPARATIVE EXAMPLES | | | |
|---|---|---|---|---|---|---|---|
| | | | | 4 | 5 | 6 | 7 |
| Electromagnetic | Soft ferrite | D₅₀ | μm | 10˜30 | 10˜30 | 10˜30 | 10˜30 |
| wave absorber | (a) | Surface treatment | — | Methyltrimethoxy | Methyltrimethoxy | Methyltrimethoxy | Methyltrimethoxy |
| composition | | agent | | silane | silane | silane | silane |
| | | pH after surface | | <8.2 | <8.2 | <8.2 | <8.2 |
| | | treatment | | | | | |
| | | Content | wt % | 83.5 | 66 | 90 | 60 |
| | Magnetite | D₅₀ | μm | 0.1˜0.4 | 0.1˜0.4 | 0.1˜0.4 | 0.1˜0.4 |
| | (c) | Content | wt % | 2.5 | 5 | 5 | 30 |
| | Silicone | Penetration | — | 150 | 150 | 150 | 150 |
| | (d) | Content | wt % | 14 | 29 | 5 | 10 |

| | | | | | | |
|---|---|---|---|---|---|---|
| Electromagnetic | Magnetism loss(1 GHz) | μ″ | 3.6 | 2.5 | 4.2 | 3.2 |
| wave absorber | Volumetric resistance | Ωm | 2 × 10¹¹ | 2 × 10¹¹ | 2 × 10¹¹ | — |
| evaluation | Dielectric breakdown strength | KV/mm | 4.5 | 5 | 4 | <1 |
| results | Thermal conductivity | W/m · K | 1.1 | 1.1 | 1.25 | 1.1 |
| | Specific gravity | — | 2.7 | 2.7 | 2.8 | 2.7 |
| | Penetration | — | 60 | 60 | 60 | 60 |
| | Flame retardancy (UL94) | — | x | V-0 | V-0 | V-0 |
| | | | | equivalent | equivalent | equivalent |
| | Heat resistance (150° C.) | — | ∘ | ∘ | ∘ | — |
| | External appearance | — | Black | Black | Black | Black |
| | Moldability (mass producibility) | — | ∘ | ∘ | x | ∘ |

### Example 3

A mixture of 50% by mass of Ni—Zn-based soft ferrite (BSN-714, Toda Kogyo, particle size distribution D₅₀: 1 to 10 μm) surface treated with methyltrimethoxy silane, 25% by mass of flat, soft magnetic metal powder (JEM-M, Jemco, particle size distribution D₅₀: 8 to 42 μm, self-oxidation rate: 0.26% by mass), 5% by mass of fine magnetite particles of octahedral shape (KN-320, Toda Kogyo, particle size distribution D₅₀: 0.1 to 0.4 μm) and 20% by mass of silicone gel (CF-5106, Toray-Dow Corning Silicone, penetration: 150, determined in accordance with JIS K2207-1980 at a load of 50 g) was prepared, defoaming-treated under a vacuum, poured into a space between glass plates carefully to prevent air from getting in the mixture, and pressed under heating at 70° C. for 60 minutes, to produce a 1 mm thick formed article of smooth surface. The evaluation results of the formed article are given in Table 2.

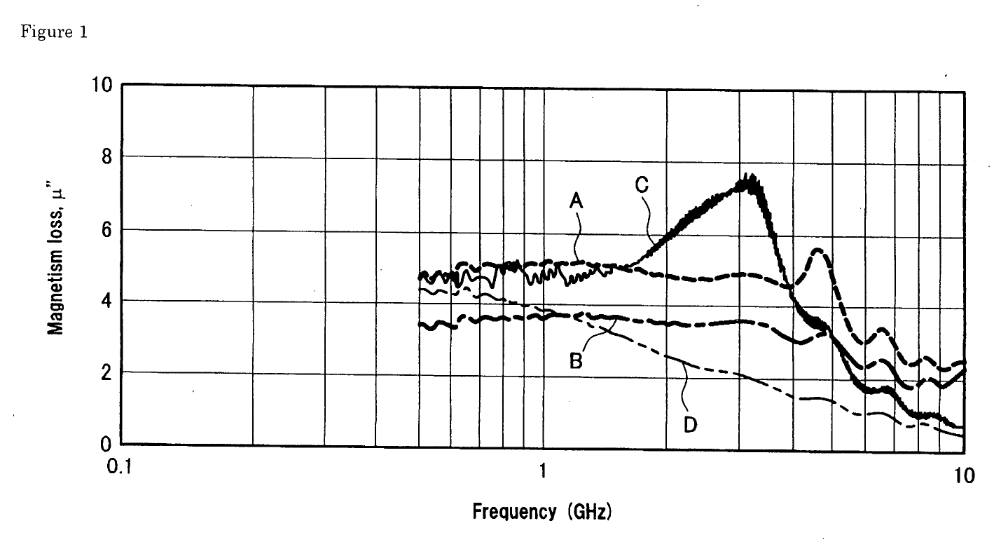

Its magnetism loss, measured in a frequency band of from 0.5 to 10 GHz, is represented by Line A shown in FIG. 1.

### Example 4

A formed article was prepared in the same manner as in EXAMPLE 3, except that the flat, soft magnetic metal powder was microcapsulated, where it was dispersed in a 20% by mass toluene solution of gelatin and then toluene was removed by evaporation to produce the gelatin-coated microcapsules (gelatin content: 20% by mass and metal powder content: 80% by mass). The evaluation results of the formed article are given in Table 2.

### Example 5

The formed article prepared in EXAMPLE 3 was coated with a 50 μm thick PET film as an electrically insulating layer, to produce the electromagnetic wave absorber. The evaluation results of the formed article are given in Table 2. The PET film was used to improve dielectric breakdown strength of the absorber.

### Example 6

A formed article was prepared in the same manner as in EXAMPLE 3, except that the soft ferrite, the flat, soft magnetic powder and magnetite silicone contents were changed as shown in Table 2. The evaluation results of the formed article are given in Table 2. Its magnetism loss, measured in a frequency band of from 0.5 to 10 GHz, is represented by Line B shown in FIG. 1.

### Comparative Example 8

A formed article was prepared in the same manner as in EXAMPLE 3, except that the soft ferrite was not surface-treated, the flat, soft magnetic metal powder and magnetite were not incorporated, and the silicone content was changed as shown in Table 2. The soft ferrite inhibited curing of the silicone even at a low 20% by mass, when it was not surface-treated, failing to produce a satisfactory article. The evaluation results of the formed article are given in Table 2.

### Comparative Example 9

A formed article was prepared in the same manner as in EXAMPLE 3, except that the soft ferrite was surface-treated with epoxy trimethoxy silane as a silane compound containing a functional group. The evaluation results of the formed article are given in Table 2. The formed article was insufficient in heat resistance.

### Comparative Example 10

A formed article was prepared in the same manner as in EXAMPLE 3, except that the soft ferrite was surface-treated with vinyl trimethoxy silane as a silane compound containing a functional group. The evaluation results of the formed article are given in Table 2. The formed article was insufficient in heat resistance.

### Comparative Example 11

A formed article was prepared in the same manner as in EXAMPLE 3, except that the magnetite content was set at below the range for the present invention, and the soft ferrite content was also changed as shown in Table 2. The evaluation results of the formed article are given in Table 2. The formed article was insufficient in flame retardancy.

### Comparative Example 12

A formed article was prepared in the same manner as in EXAMPLE 3, except that the flat, soft magnetic metal powder was not incorporated, and the soft ferrite and silicone contents were changed as shown in Table 2. The evaluation results of the formed article are given in Table 2. Its magnetism loss, measured in a frequency band of from 0.5 to 10 GHz, is represented by Line D shown in FIG. 1. The formed article was low in magnetism loss in a high frequency band of 1 GHz or more and insufficient in electromagnetic wave absorption capability.

### Comparative Example 13

A formed article was prepared in the same manner as in EXAMPLE 3, except that the soft ferrite was not incorporated, and the flat, soft magnetic metal powder and silicone contents were changed as shown in Table 2. The evaluation results of the formed article are given in Table 2. Its magnetism loss, measured in a frequency band of from 0.5 to 10 GHz, is represented by Line C shown in FIG. 1. The formed article was low in magnetism loss in a high frequency band of around 10 GHz and insufficient in electromagnetic wave absorption capability, although excellent in magnetism loss in a band of from 2 to 4 GHz.

TABLE 2

| | | | | | | | | COMPARATIVE |
|---|---|---|---|---|---|---|---|---|
| | | | | EXAMPLES | | | | EXAMPLES |
| | | | | 3 | 4 | 5 | 6 | 8 |
| Electromagnetic | Soft | D₅₀ | μm | 1˜10 | 1˜10 | 1˜10 | 1˜10 | 1˜10 |
| wave | ferrite | Surface | — | Methyl- | Methyl- | Methyl- | Methyl- | Untreated |
| absorber | (a) | treatment | | trimethoxy | trimethoxy | trimethoxy | trimethoxy | |
| composition | | agent | | silane | silane | silane | silane | |
| | | pH after surface treatment | | <8.2 | <8.2 | <8.2 | <8.2 | >8.5 |
| | | Content | wt % | 50 | 50 | 50 | 57 | 20 (upper limit) |
| | Flat, soft | D₅₀ | μm | 8˜42 | 8˜42 | 8˜42 | 8˜42 | — |
| | magnetic metal | Content | wt % | 25 | 25 | 25 | 20 | 0 |
| | powder (b) | | | | | | | |
| | Magnetite | D₅₀ | μm | 0.1˜0.4 | 0.1˜0.4 | 0.1˜0.4 | 0.1˜0.4 | — |
| | (c) | Content | wt % | 5 | 5 | 5 | 5 | 0 |
| | Silicone (d) | Penetration | — | 150 | 150 | 150 | 150 | 150 |
| | | Content | wt % | 20 | 20 | 20 | 18 | 80 |

| Measure for improving dielectric breakdown | | — | No | Micro- | Coating with a | No | No |
|---|---|---|---|---|---|---|---|
| strength | | | | capsulation | PET film | | |
| Electromagnetic | Magnetism loss | μ″ | A | — | — | B | 0.5 (1 GH) |
| wave | (1 GHz) | | | | | | |
| absorber | Volumetric | Ωm | 10⁷ | 10⁸ | — | 10⁶ | 2 × 10¹⁴ |
| evaluation | resistance | | | | | | |
| results | Dielectric breakdown | KV/mm | 0.2 | 0.4 | 1.0 | 0.2 | >10 |
| | strength | | | | | | |
| | Thermal conductivity | W/m · K | 0.8 | 0.8 | 0.8 | 0.6 | — |
| | Specific gravity | — | 3.0 | 3.0 | 3.0 | 2.6 | — |
| | Penetration | — | 40 | 40 | 40 | 50 | — |
| | Flame retardancy | — | V-0 | V-0 | V-0 | V-0 | — |
| | (UL94) | | equivalent | equivalent | equivalent | equivalent | |
| | Heat resistance | — | ∘ | ∘ | ∘ | ∘ | — |
| | (150° C.) | | | | | | |
| | External | — | Grayish | Grayish | Grayish | Grayish | Brown |
| | appearance | | black | black | black | black | |

| | | | | COMPARATIVE EXAMPLES | | | | |
|---|---|---|---|---|---|---|---|---|
| | | | | 9 | 10 | 11 | 12 | 13 |
| Electromagnetic | Soft | D₅₀ | μm | 1˜10 | 1˜10 | 1˜10 | 1˜10 | — |
| wave | ferrite | Surface | — | Epoxy | Vinyl | Methyl- | Methyl- | — |
| absorber | (a) | treatment | | trimethoxy | trimethoxy | trimethoxy | trimethoxy | |
| composition | | agent | | silane | silane | silane | silane | |
| | | pH after surface treatment | | <8.2 | <8.2 | <8.2 | <8.2 | — |
| | | Content | wt % | 50 | 50 | 52.5 | 83 | 0 |
| | Flat, soft | D₅₀ | μm | 8˜42 | 8˜42 | 8˜42 | — | 8˜42 |
| | magnetic metal | Content | wt % | 25 | 25 | 25 | 0 | 65 |
| | powder (b) | | | | | | | |
| | Magnetite | D₅₀ | μm | 0.1˜0.4 | 0.1˜0.4 | 0.1˜0.4 | 0.1˜0.4 | 0.1˜0.4 |
| | (c) | Content | wt % | 5 | 5 | 2.5 | 5 | 5 |
| | Silicone (d) | Penetration | — | 150 | 150 | 150 | 150 | 150 |
| | | Content | wt % | 20 | 20 | 20 | 12 | 30 |

| Measure for improving dielectric breakdown | | — | No | No | No | No | No |
|---|---|---|---|---|---|---|---|
| strength | | | | | | | |
| Electromagnetic | Magnetism loss | μ″ | — | — | — | D | C |
| wave | (1 GHz) | | | | | | |
| absorber | Volumetric | Ωm | 10⁷ | 10⁷ | 10⁷ | 2 × 10¹¹ | 10⁸ |
| evaluation | resistance | | | | | | |
| results | Dielectric breakdown | KV/mm | 0.2 | 0.2 | 0.2 | 4.5 | 0.2 |
| | strength | | | | | | |
| | Thermal conductivity | W/m · K | 0.8 | 0.8 | 0.8 | 1.2 | 0.6 |
| | Specific gravity | — | 3.0 | 3.0 | 3.0 | 2.8 | 2.6 |
| | Penetration | — | 40 | 40 | 40 | 60 | 50 |
| | Flame retardancy | — | V-0 | V-0 | x | V-0 | V-0 |
| | (UL94) | | equivalent | equivalent | | equivalent | equivalent |
| | Heat resistance | — | x | x | ∘ | ∘ | ∘ |
| | (150° C.) | | | | | | |
| | External | — | Grayish | Grayish | Grayish | Grayish | Grayish |
| | appearance | | black | black | black | black | black |

### Example 7

A mixture of 83% by mass of Ni—Zn-based soft ferrite (BSN-828, Toda Kogyo, particle size distribution D₅₀: 10 to 30 μm) surface treated with methyltrimethoxy silane, 5% by mass of fine magnetite particles of octahedral shape. (KN-320, Toda Kogyo, particle size distribution D₅₀: 0.1 to 0.4 μm) and 12% by mass of silicone gel (CF-5106, Toray-Dow Corning Silicone, penetration: 150, determined in accordance with JIS K2207-1980 at a load of 50 g) was prepared, defoaming-treated under a vacuum, poured into a space between glass plates carefully to prevent air from getting in the mixture, and pressed under heating at 70° C. for 60 minutes, to produce a 1 mm thick sheet of smooth surface for electromagnetic wave absorption.

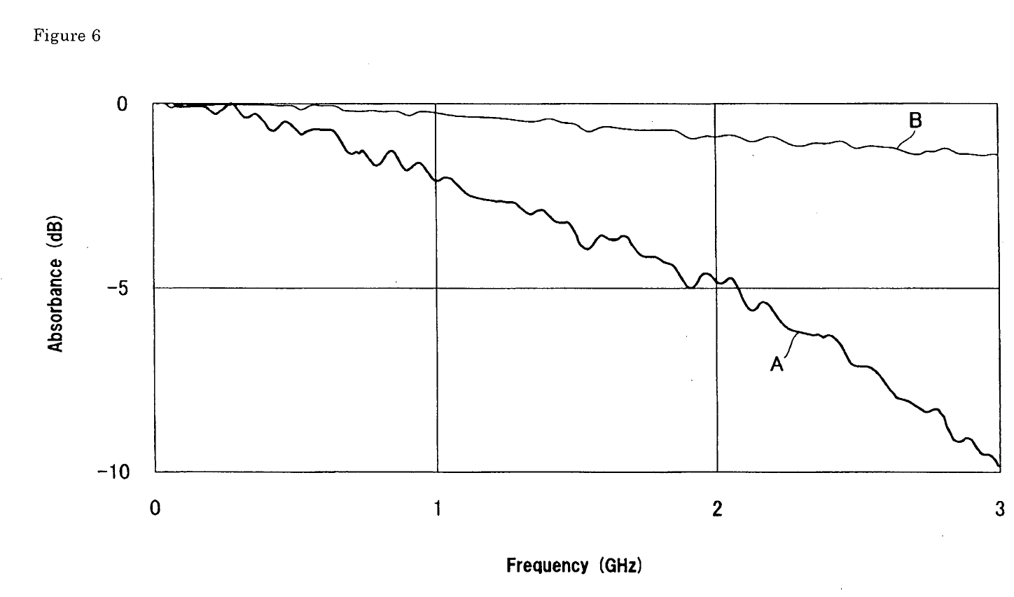

The sheet was used to produce a laminated electromagnetic wave absorber which comprised a 20 μm thick releasable film of PET, the above sheet for electromagnetic wave absorption, aluminum foil, 50 μm thick PET film, 1 μm thick adhesive layer and 20 μm thick releasable film of PET, in this order. The laminate lacking an aluminum foil was also prepared for comparison. Their electromagnetic wave absorbances in neighborhood electromagnetic fields were measured. The results are given in FIG. 6, where Line A represents the results of the former absorber and Line B represents those of the latter.

The laminated absorber had following properties; magnetism loss μ″ (1 GHz): 4.0, volumetric resistance: 2×10¹¹ Ω·cm, dielectric breakdown strength: 4.5 kV/mm, thermal conductivity: 1.2 W/m·K, specific gravity: 2.8, penetration: 60, flame retardancy (UL94): V-0 equivalent, and heat resistance: 1000 hours or more.

The electromagnetic wave absorber of the present invention is excellent in electromagnetic wave absorbing capability, thermal conductivity and flame retardancy, having limited temperature dependency, soft, excellent in adhesive strength, and having high electric resistance/insulation characteristics. In particular, it is well balanced in high electric resistance/insulation characteristics, thermal conductivity and electromagnetic wave absorbing capability. As such, it can be bonded to widely varying objects, e.g., cable, high-speed arithmetic element, pattern on a printed board and so forth.

Moreover, it also has a stable energy conversion efficiency in a broad frequency band from MHz to 10 GHz, in addition to many advantages of being excellent in electromagnetic wave absorption capability, thermal conductivity and flame retardancy, having limited temperature dependency, being soft, excellent in adhesive strength, having high electric resistance/insulation characteristics, and fast bonded to widely varying objects.

Still more, it comprises a releasable film, electromagnetic wave absorption layer, electromagnetic wave reflection layer, electric insulation layer, adhesive layer and releasable film layer, in this order, and can be bonded to a box ceiling surface, high-speed arithmetic element and so forth. With its excellent electromagnetic wave absorbing and shielding effects, it can be used to absorb unnecessary electromagnetic waves in neighborhood electromagnetic fields, e.g., those around a broadcasting device, cellular phone, wireless LAN and so forth.

1. An electromagnetic wave absorber containing (a) a soft ferrite surface-treated with a silane compound having a non-functional group at 60 to 90% by mass, (C) magnetite at 3 to 25% by mass and (d) silicone at 7 to 15% by mass.

2. An electromagnetic wave absorber containing (a) soft ferrite surface-treated with a silane compound having a non-functional group at 40 to 60% by mass, (b) flat, soft magnetic metal powder at 20 to 30% by mass, (c) magnetite at 3 to 10% by mass and (d) silicone at 7 to 25% by mass.

3. The electromagnetic wave absorber according to claim 2, wherein ratio of (a) the soft ferrite surface-treated with a silane compound having a non-functional group to (b) the flat, soft magnetic metal powder is 1.8 to 2.3/1 by mass.

4. The electromagnetic wave absorber according to claim 1, wherein (a) the soft ferrite surface-treated with a silane compound having a non-functional group is surface-treated with dimethyldimethoxy silane or methyltrimethoxy silane.

5. The electromagnetic wave absorber according to claim 1, wherein (a) the soft ferrite surface-treated with a silane compound having a non-functional group is kept at a pH of 8.5 or less.

6. The electromagnetic wave absorber according to claim 1, wherein (a) the soft ferrite surface-treated with a silane compound having a non-functional group is composed of the powder having a particle size distribution D₅₀ of 1 to 30 μm.

7. The electromagnetic wave absorber according to claim 1, wherein (a) the soft ferrite surface-treated with a silane compound having a non-functional group is Ni—Zn-based one.

8. The electromagnetic wave absorber according to claim 2, wherein (b) the flat, soft magnetic metal powder is of a low self-oxidation type showing a mass change rate of 0.3% or less in an atmospheric exposure test under heating.

9. The electromagnetic wave absorber according to claim 2, wherein (b) the flat, soft magnetic metal powder has a specific surface area of 0.8 to 1.2 m²/g.

10. The electromagnetic wave absorber according to claim 2, wherein (b) the flat, soft magnetic metal powder is composed of the particles having a size distribution D₅₀ of 8 to 42 μm.

11. The electromagnetic wave absorber according to claim 2, wherein (b) the flat, soft magnetic metal powder is microcapsulation-treated.

12. The electromagnetic wave absorber according to claim 1, wherein (c) the magnetite is composed of the particles having a size distribution D₅₀ of 0.1 to 0.4 μm.

13. The electromagnetic wave absorber according to claim 1, wherein (c) the magnetite is composed of the fine, octahedral particles.

14. The electromagnetic wave absorber according to claim 1, wherein (d) the silicone is gelled one having a penetration of 5 to 200, determined in accordance with JIS K2207-1980 (load: 50 g).

15. A laminated electromagnetic wave absorber comprising an electromagnetic wave absorption layer of the electromagnetic wave absorber according to claim 1, coated with an electroconductive reflection layer and electrical insulation layer, in this order.

16. The laminated electromagnetic wave absorber according to claim 15 which can absorb unnecessary electromagnetic waves emitted from a resin box inside and outside, comprises the electromagnetic wave absorption layer coated with an electroconductive layer for reflecting electromagnetic waves, electric insulation layer and adhesive layer, in this order, each of the electromagnetic wave absorption layer and adhesive layer being coated with a releasable film layer on the other side, wherein the electromagnetic wave absorption layer is sufficiently adhesive to be fast bonded at least to a high-speed arithmetic element, and adhesive layer can be kept attached at least to a horizontal glass ceiling surface.

17. The laminated electromagnetic wave absorber according to claim 15, wherein an electrical insulation layer is provided between the electromagnetic wave absorption layer and electromagnetic wave reflection layer.

18. The laminated electromagnetic wave absorber according to claim 15, wherein the electromagnetic wave reflection layer is a metallic layer of aluminum.

19. The laminated electromagnetic wave absorber according to claim 15, wherein the adhesive layer is of an acrylic resin.

20. The laminated electromagnetic wave absorber according to claim 15, wherein the electric insulation layer is of a polyethylene terephthalate resin.
